(19) United States
(12) Patent Application Publication
(10) Pub. No.: US 2014/0243181 A1
(43) Pub. Date: Aug. 28, 2014

(54) BLOOD AND BONE MARROW SIMULANT

(71) Applicant: ORTHOVITA, INC., Malvern, PA (US)

(72) Inventor: Stephen E. McIlhenny, Lansdale, PA (US)

(73) Assignee: ORTHOVITA, INC., Malvern, PA (US)

(21) Appl. No.: 13/781,065

(22) Filed: Feb. 28, 2013

(51) Int. Cl. G01N 1/40; B65D 85/00; B01D 21/26

(52) U.S. Cl. CPC G01N 1/4077; B01D 21/26; B65D 85/00
USPC 494/37; 252/408.1; 206/223

(57) ABSTRACT

In one aspect of the present invention is a blood simulant comprising an aqueous component, a non-aqueous component, a stabilizer, and a red dye soluble in the aqueous component and substantially insoluble in the non-aqueous component. In some embodiments, the blood simulant simulates whole blood or its components. In other embodiments, the simulant simulates bone marrow aspirates or its components. Methods of forming the simulants are also disclosed.

### BACKGROUND OF THE INVENTION

Whole blood and bone marrow aspirate are each comprised of many components, including red blood cells, white blood cells, platelets and plasma. These constituent components may be separated from each other when the whole blood or bone marrow aspirate sample is centrifuged. FIG. 1a shows a vial 10 containing whole blood 11, both before and after centrifugation. After being spun in a centrifuge, the whole blood 11 separates into a plasma layer 12, a buffy coat layer 13, and a layer containing red blood cells 14.

Red blood cells (RBCs) are flexible biconcave cells packed with hemoglobin which carry oxygen throughout the body. RBCs are the most dense whole blood component and thus can be readily separated from whole blood, e.g., by centrifugation or even by permitting settling under the force of gravity (layer 14 of FIG. 1a). White blood cells (WBCs) are a diverse array of cell types, e.g., lymphocytes, macrophages, and polymorphonuclear neutrophils (PMNs), which are primarily involved with immune responses and fighting infections. WBCs are generally somewhat less dense than RBCs and, together with platelets, form a white “buffy coat” layer (layer 13 of FIG. 1a) on top of RBCs during centrifugation of whole blood.

Platelets are cell fragments shed into the blood stream by large megakaryocyte cells in the bone marrow. Platelets play an important role in coagulation of blood. Platelets settle through plasma more slowly than RBCs and WBCs due to their low density and small size. When whole blood is centrifuged, platelets can be found distributed in the plasma, in the buffy coat, and/or in the upper portion of the red cells, depending on the centrifugation time and centripetal forces involved.

Blood and bone marrow aspirate are commonly used in laboratory research, diagnostics and training, particularly in testing medical devices. Typically, this research is performed by obtaining human or animal blood or bone marrow aspirate. Using these fluids can pose a safety issue, particularly in the case of human blood and bone marrow, which carries the risk of disease transmission. These fluids can also be very costly and may be difficult to obtain. As such, there is a need in the field for a synthetic material that serves to simulate blood and bone marrow aspirate for experimental purposes in the lab (in-vitro).

### BRIEF SUMMARY OF THE INVENTION

In one aspect of the present invention is a simulant comprising an aqueous component, a non-aqueous component, a stabilizer, and a red dye soluble in the aqueous component and substantially insoluble in the non-aqueous component. In some embodiments, the simulant is In some embodiments, the blood simulant simulates whole blood or its components. In other embodiments, the simulant simulates bone marrow aspirates or its components. In some embodiments, the blood simulant is in the form of a suspension.

In some embodiments, the non-aqueous component is less dense than the aqueous component. In some embodiments, the non-aqueous component is selected from the group consisting of oils, organic solvents, animal fats, fatty acids, and waxes. In some embodiments, the oil is vegetable oil.

In general, the total amount of non-aqueous component may range from 45% to 80% by total volume of the composition. In some blood simulant embodiments, the amount of non-aqueous component ranges from about 45% to about 65% by total volume of the blood simulant. In other blood simulant embodiments, the amount of non-aqueous component ranges from about 50% to about 60% by total volume of the blood simulant. In yet other blood simulant embodiments, the amount of non-aqueous component is about 55% by total volume of the blood simulant.

In some embodiments in which the simulant is intended to be used to simulate bone marrow aspirate, the amount of non-aqueous component ranges from about 70% to about 80% by total volume of the blood simulant.

In some embodiments, the aqueous component is selected from the group consisting of water, buffered water solutions, weakly acidic acids, organic acids, salt solutions, glycerol solutions, and mixtures thereof. In some embodiments, the aqueous component is water or acetic acid.

In general, the total amount of aqueous component may range from 20% to 55% by total volume of the composition. In some blood simulant embodiments, the amount of aqueous component ranges from about 35% to about 55% by total volume of the blood simulant. In other blood simulant embodiments, the amount of aqueous component ranges from about 40% to about 50% by total volume of the blood simulant. In yet other blood simulant embodiments, the amount of aqueous component is about 45% by total volume of the blood simulant.

In some embodiments in which the simulant is intended to be used to simulate bone marrow aspirate, the amount of aqueous component ranges from about 20% to about 30% by total volume of the blood simulant.

In some embodiments, the stabilizer is selected from the group consisting of xanthan gum, guar gum, corn starch, carrageenan, propylene glycol alginate, algininc acid, locust beam gum, arrow root, pectin, agar, Arabic gum, soy lecithin, and sodium stearoyl lactylate. In other embodiments, the stabilizer is xanthan gum. In some embodiments, the stabilizer is present in an amount ranging from about 0.01% to about 1% by total volume of the blood simulant.

In another aspect of the present invention is a method of simulating blood separation comprising the steps of (a) providing a suspension having a red blood cell simulant, a plasma simulant, a buffy coat simulant, and a stabilizer; (b) placing the suspension in a centrifugation apparatus; and (c) applying a centrifugal force such that the suspension separates into discrete layers of red blood cell simulant, buffy coat simulant, and plasma simulant. In some embodiments, the red blood simulant comprises an aqueous component having a red dye, colorant, or pigment solubilized therein, and where the red dye, colorant, or pigment is substantially insoluble in the plasma simulant. In some embodiments, the red blood simulant comprises water and a red dye, colorant, or pigment soluble in the water; the plasma simulant comprises an oil; and wherein the suspension further comprises xanthan gum.

In another aspect of the present invention is a method of making a synthetic simulant comprising the steps of (1) providing a non-aqueous component in a container, (2) adding an aqueous component to the container, (3) adding a stabilizing agent to the container, (4) adding a colorant to the container, and (5) agitating or mixing the container to form a suspension. In some embodiments, steps (1), (2), (3), and (4) may be added in any order. In some embodiments, the step of agitating or mixing the container comprises shaking by applying vibration to the container, vortexing the container, inverting the container, or stirring the container.

In some blood simulant embodiments, the amount of non-aqueous component ranges from about 45% to about 80% by total volume of the blood simulant, the amount of aqueous component ranges from about 20% to about 55% by total volume of the blood simulant, and the amount of stabilizing agent ranges from about 0.01% to about 1% by total volume of the blood simulant.

In some blood simulant embodiments, the amount of non-aqueous component ranges from about 50% to about 60% by total volume of the blood simulant, the amount of aqueous component ranges from about 40% to about 50% by total volume of the blood simulant, and amount of the stabilizing agent ranges from about 0.01% to about 0.5% by total volume of the blood simulant.

In another aspect of the present invention is a kit comprising a red blood cell simulant, a buffy coat simulant, a plasma simulant, and at least one container. In some embodiments, the kit further comprises instructions for preparing a blood simulant or bone marrow aspirate simulant. In some embodiments, the red blood cell simulant, the buffy coat simulant, and the plasma simulant are in the form of a suspension.

In another aspect of the present invention is a kit comprising an aqueous component, a non-aqueous component, a stabilizer, and a red dye, colorant, or pigment soluble in the aqueous component and substantially insoluble in the non-aqueous component, and a container. In some embodiments, the kit further comprises instructions for forming a suspension. In some embodiments, the kit further comprises instructions for centrifugation of the suspension.

### BRIEF DESCRIPTION OF THE DRAWINGS

FIGS. 1a and 1b are drawings illustrating the similarities between natural human whole blood (pre- and post-spin) and the synthetic simulated whole blood of the present invention (pre- and post-spin).

FIGS. 2a through 2d are photos illustrating the similarities between natural human whole blood (pre- and post-spin) and the synthetic simulated whole blood of the present invention (pre- and post-spin).

FIG. 3 provides drawings illustrating the similarities between natural human bone marrow aspirate separated into its constituent components and the synthetic bone marrow aspirate of the present invention separated into its constituent components.

### DETAILED DESCRIPTION

The present invention is directed to a whole blood and/or bone marrow simulant (collectively “simulant” or “synthetic simulant”). In some embodiments, the simulant comprises a plasma simulant, a red blood cell simulant, and a buffy coat simulant.

In some embodiments, the simulant is used for demonstrating blood separation or plasma separation; demonstrating bone graft materials; separation or centrifugation training; and/or other medical demonstrations. In other embodiments, the simulant is used for novelty purposes. In other embodiments, the blood and/or bone marrow simulant simulates human or animal whole blood and/or human or animal bone marrow aspirates.

In some embodiments, the simulant is comprised of two normally immiscible liquids. A first liquid is an aqueous component, which at least partially defines the red blood cell simulant. A second liquid is a non-aqueous component, which at least partially defines the plasma simulant.

When the aqueous and non-aqueous components are combined in appropriate concentrations, with or without additional components, the resulting combination (believed to be in the form of a suspension) simulates the appearance and/or physical properties, including in some embodiments the viscosity, of whole blood or bone marrow aspirates. When the simulant suspension is centrifuged, the aqueous and non-aqueous components (i.e. individual simulant layers) separate in a manner mimicking the separation of natural whole blood or natural bone marrow aspirates (derived from human or animal sources) when those natural fluids/mixtures are similarly centrifuged.

It will be appreciated that the present invention satisfies the outstanding need for a blood simulant or bone marrow aspirate simulant that could be used to train medical practitioners without the need for wasting human or animal blood or bone marrow aspirates, let alone having to use natural materials that could potentially contain infectious agents or which could spoil over time.

One of ordinary skill in the art will be able to select the appropriate components in the appropriate amounts to arrive at a whole blood simulant or bone marrow aspirate simulant which approximates the volumes of each of the components of natural whole blood or bone marrow aspirates when each of those are separated by centrifugation.

It should be understood that although the present invention is described in relation to the medical device industry, it can also find utility in the the film industry or commercially as an alternative to fake blood. For instance, the present invention may find particular utility as a commodity useful during the Halloween season. The invention is particularly useful in these instances due to the safe nature of the components of which the present invention simulant is comprised.

Any aqueous component may be selected provided that (1) the density of the aqueous component is greater than the non-aqueous component; and (2) is able to homogeneously solubilize or disperse a dye, colorant or pigment. Preferably, the aqueous component is a non-toxic component.

In general, the amount of aqueous component may comprise between about 20% to about 55% by total volume of the simulant. This amount may be altered based on whether it is desired to simulate whole blood or bone marrow aspirate.

In some blood simulant embodiments, the amount of aqueous component comprises between about 35% and about 55% by total volume of the composition. In other blood simulant embodiments, the amount of aqueous component comprised between about 40% and about 50% by total volume of the composition.

In some bone marrow aspirate embodiments, the amount of aqueous component comprises between about 20% and about 40% by total volume of the composition. In other bone marrow aspirate embodiments, the amount of aqueous component comprises between about 20% and about 30% by total volume of the composition.

Representative examples of aqueous components include water, buffered water solutions (e.g. phosphate buffered saline), weakly acidic acids (e.g. acetic acid, trichloracetic acid, citric acid, formic acids, hydrofluoric acids), organic acids, salt solutions (e.g. sodium chloride solutions, potassium chloride solutions), glycerol solutions, sugar solutions (e.g. sucrose, dextrose, etc.) and mixtures thereof.

In some embodiments, the aqueous component is an acetic acid solution. In other embodiments, the aqueous component is an acetic acid solution having a molarity ranging from about 0.1M to about 4.0M. In yet other embodiments, the aqueous component is 1M acetic acid.

The aqueous component also comprises a soluble dye, colorant or pigment. The purpose of the dye, colorant or pigment is to enhance the simulation of whole blood or bone marrow aspirate by allowing the aqueous portion to better resemble the red blood cell component of whole blood or bone marrow aspirate. In some embodiments, the dye, colorant or pigment is water soluble and provides a red color to the aqueous component. In some embodiments, the dye, colorant or pigment is substantially insoluble in the non-aqueous component (e.g. no more than 10% of the dye, colorant or pigment dissolves or admixes in the non-aqueous layer).

In some embodiments, the dye, colorant or pigment is derived from beet juice. In other embodiments, synthetic dyes are used, including those comprising Red 40 (Allura Red AC). In some embodiments, the amount of dye, colorant, or pigment should not exceed about 1% by total volume of the simulant composition. In some embodiments, the amount of dye, colorant, or pigment ranges from about 0.1% to about 1% by total volume of the simulant.

The materials employed for the non-aqueous component are known to those of ordinary skill in the art. Indeed, any non-aqueous component may be used provided it meets the criteria of the present invention and, of course, is compatible with the other components selected. For example, the non-aqueous component must be able to form a plasma simulant layer that resembles human plasma once separated, including such physical properties as viscosity and/or color.

Representative examples of non-aqueous components include oils (e.g. vegetable oils, mineral oils, and silicone oils), organic solvents, animal fats, and fatty acids (e.g. caprylic acid, lauric acid, palmitic acid, etc.), small particles and nano-particles (cork, Styrofoam®, certain polymers) and waxes. Preferably, the non-aqueous component is selected from a non-toxic component. In some embodiments, the non-aqueous component is mineral oil.

In general, the amount of non-aqueous component ranges from about 45% to about 80% of the total volume of simulant. This amount may be altered based on whether it is desired to simulate whole blood or bone marrow aspirate.

In some blood simulant embodiments, the amount of non-aqueous component comprises between about 45% and about 65% by total volume of the composition. In other blood simulant embodiments, the amount of non-aqueous component comprises between about 50% and about 60% by total volume of the composition. In yet other blood simulant embodiments, the amount of non-aqueous component comprises about 55% by total volume of the composition.

In some bone marrow aspirate embodiments, the amount of non-aqueous component ranges from about 60% to about 85% by total volume of the simulant. In other bone marrow aspirate embodiments, the amount of non-aqueous component ranges from about 70% to about 80% by total volume of the simulant.

In some embodiments, the non-aqueous component is selected such that it comprises a color consistent with that of plasma of natural whole blood or bone marrow aspirate. For example, some vegetable oils have a natural straw color which closely resembles the color and/or hue of natural plasma. Of course, a dye, colorant, or pigment that is soluble only in the non-aqueous component may be added to provide the requisite color for this simulant layer.

In some embodiments, the aqueous component is a weakly acidic acid and the non-aqueous component is an oil. In other embodiments, the aqueous component is acetic acid or citric acid and the non-aqueous component is mineral oil or a vegetable oil. In yet other embodiments, the aqueous component is acetic acid and the non-aqueous component is mineral oil. In yet further embodiments, the aqueous component is water, and the non-aqueous component is mineral oil.

In some embodiments, the aqueous and non-aqueous components are selected to provide a viscosity that closely resembles natural whole blood or bone marrow aspirate, for example the viscosity of blood at room temperature or the viscosity of blood at body temperatures. For example, the viscosity of the simulant may, in some embodiments, range from 3-4 Pa*s. Those of skill in the art will appreciate that the viscosity may be modified by varying the types of components used (based on each component's intrinsic viscosities), their relative amounts, and/or by adding additives (stabilizers, thickeners, viscosity modifiers, etc.)

As detailed further herein, the aqueous component (with or without colorant) and non-aqueous components are mixed together. To prevent the normal separation of the aqueous and non-aqueous phases into two discrete layers (such as would occur over time), in some embodiments, a stabilizer may be added. Suitable stabilizers include xanthan gum, guar gum, corn starch, carrageenan, propylene glycol alginate, algininc acid (alginate), locust beam gum, arrow root, pectin, agar, Arabic gum, soy lecithin, and sodium stearoyl lactylate. In some embodiments, the stabilizer is xanthan gum.

In some embodiments, the amount of stabilizer ranges from about 0.01% to about 5.0% by total volume of the composition. In other embodiments, the amount of stabilizer ranges from about 0.05% to about 2.0% by total volume of the composition. In yet other embodiments, the amount of stabilizer ranges from about 0.075% to about 1.5% by total volume of the composition. In yet further embodiments, the amount of stabilizer ranges from about 0.1% to about 1.0% by total volume of the composition.

Other additives may be added to simulant to assist in further stabilizing the components. For example, depending on the components chosen, an anti-foaming agent may be added such that no foam or bubbles are generated when the simulant components are mixed or centrifuged. Additionally, preservatives may be added to maintain the shelf-life of any individual components. One of ordinary skill in the art will readily be able to determine what additional components could be added, if any, depending on the aqueous and non-aqueous components selected.

Also disclosed herein are methods of producing a blood simulant. The blood simulant is manufactured by combining the aqueous component, non-aqueous component, dye, colorant, or pigment and stabilizer in a suitable container. The components may, of course, be added to the container in any order. Any suitable collection device, vial, centrifugation tube or container (collectively “container”), either evacuated or non-evacuated, is contemplated for use with the invention described herein. Of course, those skilled in the art may modify any container in accordance with the present invention to render it suitable for use. Some containers include blood collection tubes, syringes or a plasma separation devices (e.g. VitaPrep® available from OrthoVita), a syringe, VACUTAINER® available from Becton Dickenson (Becton, Dickinson and Company, Franklin Lakes, N.J.,)). In some embodiments, the containers are sealed by rubber or silicon pierceable caps.

After the components are combined in the appropriate amounts, the components are mixed. As used herein, the term “mixing” means shaking, stirring, vibrating, agitating, or inverting the components in a suitable vessel or container. Generally, the components are mixed for between about 1 minutes and about 30 minutes depending on manufacturing volume. Once mixed, the components resemble drawn whole blood or drawn bone marrow aspirate. In some embodiments, the components are not mixed until the stabilizer is added.

Following the mixing of the components, the simulant may be transferred to a different storage vessel or container to facilitate the handling of the simulant or its ability to be used as a training or demonstration tool, or for dispensing when used for novelty purposes.

To separate the constituent components of the simulant, namely the red blood cell simulant, buffy coat simulant, and plasma simulant into discrete layers, the simulant is centrifuged. Any centrifuge known in the art suitable for blood component separation may be used for this purpose. Suitable centrifuges include those manufactured by Eppendorf, Thermo, Beckman Coulter, Brinkman, and Cloe-Palmer.

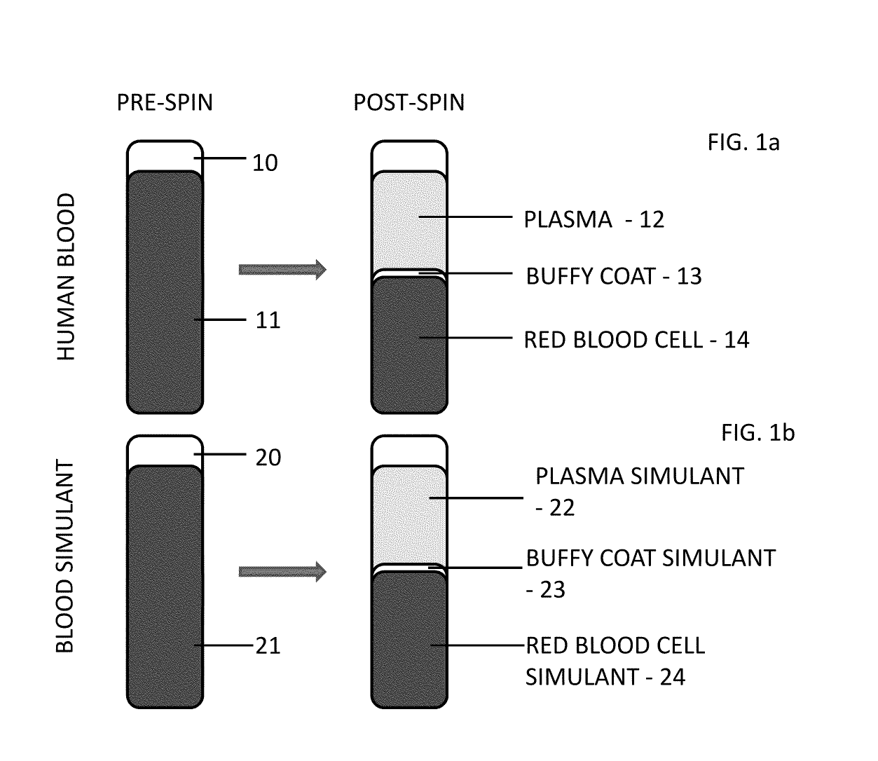

The simulant may be centrifuged at any speed (and for any duration) to achieve the desired separation as known in the art. The simulant can be centrifuged to cause separation of the whole simulant 21 into constituent red blood simulant 24, plasma simulant 22, and buffy coat simulant 23, as shown in FIG. 1b.

Once the simulant layers are separated, they may, of course, be further transferred to other containers. For example, the plasma simulant may be transferred to a plasma collection tube. In some embodiments the simulant may be resuspended via mixing, vortexing, shaking, or the like so that it may be reused.

In another aspect of the present invention is a method of simulating blood separation comprising the steps of (a) providing a suspension of a red blood simulant, a plasma simulant, a buffy coat simulant, and a stabilizer; (b) placing the suspension in a centrifugation apparatus; and (c) applying a centrifugal force such that the suspension separates into individual red blood cell simulant, buffy coat simulant, and plasma simulant layers. In these embodiments, a practitioner, trainer, or student is provided with a container comprising the blood simulant and then allowed to train or practice centrifuging the blood simulant, as one would do with drawn human or animal blood or bone marrow aspirate.

According to another embodiment, is a kit having a container, and a suspension comprising a red blood cell simulant, a buffy coat simulant, and a plasma simulant. In some embodiments, the kit further comprises additional containers, simulant transfer devices, and/or instructions.

In another aspect of the present invention is a kit comprising: (a) an aqueous component, (b) a non-aqueous component, (c) a stabilizer, (d) a red dye soluble in the aqueous component, and (e) substantially insoluble in the non-aqueous component and a container. In some embodiments, the kit further comprises instructions for forming a suspension. In some embodiments, the kit further comprises instructions for centrifugation of the suspension. In some embodiments, the kit further includes instructions for transferring a plasma simulant layer from the container to a second container.

### EXAMPLE 1

### Blood Simulant Preparation

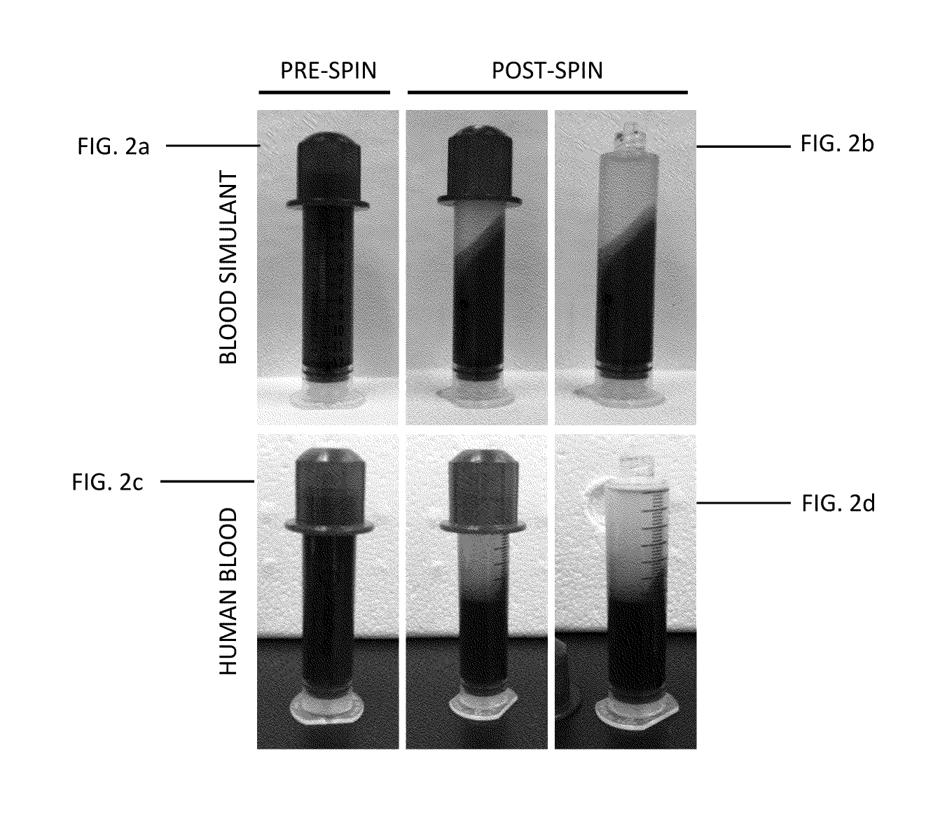

An aqueous composition was formed comprising 1M acetic acid and beet juice extract and added to a container. A non-aqueous composition comprising mineral oil was added to the container. A stabilizer, namely xanthan gum, was added last to the container. The container was then sealed. The sample contained about 55% mineral oil, about 43.5% acetic acid, about 0.5% xanthan gum, and about 1% beet juice extract by total volume. The sample was then agitated to form the blood simulant. The blood simulant “pre-spin” is shown in FIG. 2a. The blood simulant closely resembles that of human blood shown in FIG. 2c.

### EXAMPLE 2

### Blood Simulant Preparation Prior to Centrifugation

In some embodiments, it is necessary to “reconstitute” the blood simulant prior to centrifugation or use by practitioners. In this regard, the container containing the blood simulant is merely inverted two to five times, or agitated on a vortexing machine.

### EXAMPLE 3

### Centrifugation of Blood Simulant

The blood simulant of Examples 1 or 2 were centrifuged at about 4000 rpm for about 2 minutes in a 6 inch radius centrifuge. The blood simulant separated into constituent components after centrifugation, (red blood simulant, plasma simulant, and buffy coat simulant) is shown in FIG. 2b. The separated components closely resemble that of human blood components shown in FIG. 2d.

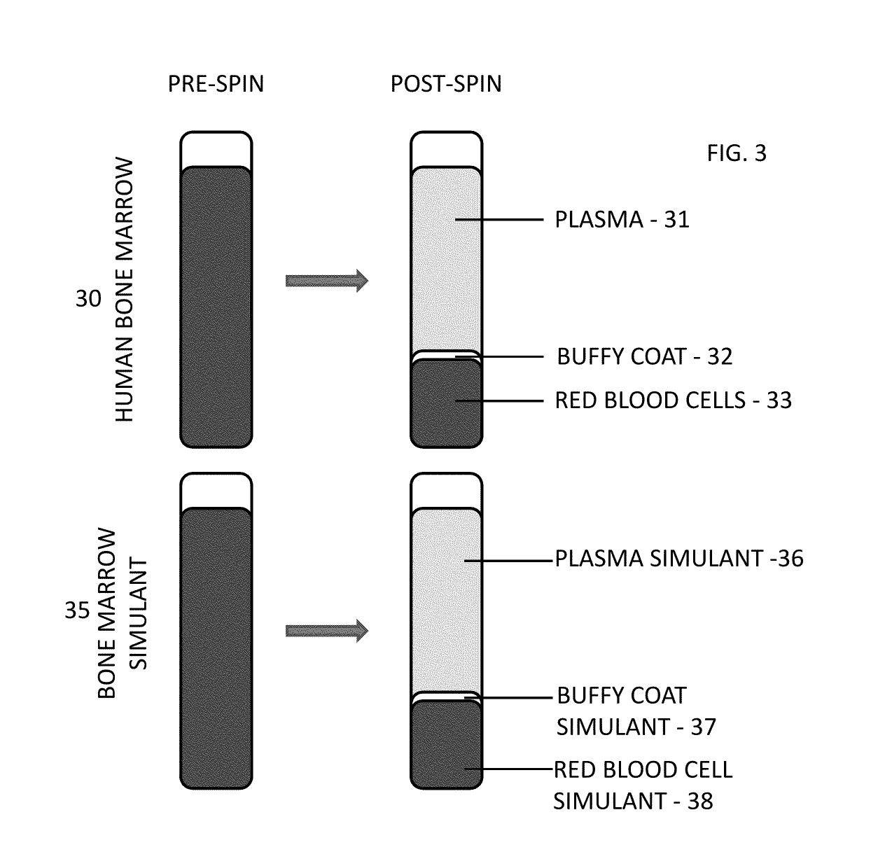

FIG. 3 provides drawings illustrating the similarities between natural human bone marrow aspirate separated into its constituent components and synthetic bone marrow aspirate separated into its constituent components. Each of the natural bone marrow aspirate 30 and the simulant bone marrow aspirate 35 have a plasma layer 31 or 36 (or plasma simulant layer), a buffy coat layer 32 or 37 (or a buffy coat simulant layer), and a layer containing red blood cells 33 or 38 (a red blood cell simulant layer).

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A simulant comprising an aqueous component, a non-aqueous component, a stabilizer, and a red dye soluble in said aqueous component and substantially insoluble in said non-aqueous component.

2. The simulant of claim 1, wherein said simulant is in the form of a suspension.

3. The simulant of claim 1, wherein said non-aqueous component is less dense than said aqueous component.

4. The simulant of claim 1, wherein said non-aqueous component is selected from the group consisting of oils, organic solvents, animal fats, fatty acids, and waxes.

5. The simulant of claim 4, wherein said oil is vegetable oil.

6. The simulant of claim 1, wherein an amount of said non-aqueous component ranges from about 45% to about 80% by total volume of said simulant.

7. The simulant of claim 1, wherein an amount of said non-aqueous component ranges from about 45% to about 65% by total volume of said simulant.

8. The simulant of claim 1, wherein an amount of said non-aqueous component ranges from about 50% to about 60% by total volume of said simulant.

9. The simulant of claim 1, wherein an amount of said non-aqueous component ranges from about 70% to about 80% by total volume of said simulant.

10. The simulant of claim 1, wherein said aqueous component is selected from the group consisting of water, buffered water solutions, weakly acidic acids, organic acids, salt solutions, glycerol solutions, and mixtures thereof.

11. The simulant of claim 10, wherein said aqueous component is water.

12. The simulant of claim 1, wherein an amount of said aqueous component ranges from about 20% to about 55% by total volume of said simulant.

13. The simulant of claim 1, wherein an amount of said aqueous component ranges from about 35% to about 55% by total volume of said simulant.

14. The simulant of claim 1, wherein an amount of said aqueous component ranges from about 40% to about 50% by total volume of said simulant.

15. The simulant of claim 1, wherein an amount of said aqueous component ranges from about 20% to about 30% by total volume of said simulant.

16. The simulant of claim 1, wherein said stabilizer is selected from the group consisting of xanthan gum, guar gum, corn starch, carrageenan, propylene glycol alginate, algininc acid (alginate), locust beam gum, arrow root, pectin, agar, Arabic gum, soy lecithin, and sodium stearoyl lactylate.

17. The simulant of claim 1, wherein an amount of said stabilizer ranges from about 0.01% to about 1.0% by total volume of said simulant.

18. A method of simulating blood separation comprising the steps of (a) providing a suspension having a red blood cell simulant, a plasma simulant, and a buffy coat simulant; (b) placing said suspension in a centrifugation apparatus; and (c) applying a centrifugal force such that said suspension separates into individual red blood cell simulant, buffy coat simulant, and plasma simulant layers.

19. The method of claim 18, wherein at least one of said simulants comprises a stabilizer.

20. The method of claim 18, wherein said red blood simulant comprises an aqueous component having a red dye solubilized therein, and where said red said is substantially insoluble in said plasma simulant.

21. The method of claim 18, wherein said red blood simulant comprises water and a red dye soluble in said water, said plasma simulant comprises an oil, and wherein said suspension further comprises xanthan gum.

22. A method of making synthetic simulant comprising the steps of (1) providing a non-aqueous component in a container, (2) adding an aqueous component to said container, (3) adding a stabilizing agent to said container, (4) adding a colorant to said container, and (5) agitating or mixing said container to form a suspension having a red blood cell simulant, a plasma simulant, and a buffy coat simulant.

23. The method of claim 22, wherein the step of agitating or mixing said container comprises shaking by applying vibration to said container, vortexing said container, inverting said container, or stirring said container.

24. The method of claim 22, wherein an amount of said non-aqueous component ranges from about 45% to about 80% by total volume of said simulant, an amount of said aqueous component ranges from about 20% to about 55% by total volume of said simulant, and an amount of said stabilizing agent ranges from about 0.01% to about 1% by total volume of said simulant.

25. The method of claim 22, wherein an amount of said non-aqueous component ranges from about 45% to about 65% by total volume of said simulant, an amount of said aqueous component ranges from about 35% to about 55% by total volume of said simulant, and an amount of said stabilizing agent ranges from about 0.01% to about 0.5% by total volume of said simulant.

26. The method of claim 22, wherein an amount of said non-aqueous component ranges from about 70% to about 80% by total volume of said simulant, an amount of said aqueous component ranges from about 20% to about 30% by total volume of said simulant, and an amount of said stabilizing agent ranges from about 0.01% to about 0.5% by total volume of said simulant.

27. A kit comprising a red blood cell simulant, a buffy coat simulant, a plasma simulant, and at least one container.

28. The kit of claim 27, further comprising instructions for preparing a simulant or bone marrow aspirate simulant.

29. The kit of claim 27, wherein said red blood cell simulant, said buffy coat simulant, and said plasma simulant are in the form of a suspension.

30. A kit comprising the simulant of claim 1 and a container.

31. The kit of claim 30, further comprising instructions for forming a suspension.

32. The kit of claim 31, further comprising instructions for centrifugation of said suspension.

33. The kit of claim 32, further comprising a transfer device and a second container.

34. The kit of claim 33, further comprising instructions for transferring plasma simulant from said container to a second container.
